(19) United States
(12) Patent Application Publication
(10) Pub. No.: US 2003/0010712 A1
(43) Pub. Date: Jan. 16, 2003

(54) Process for biochemical treatment of waste water using nano materials

(76) Inventors: Minghua Gao, Beijing (CN); Jincheng Xue, Beijing (CN); Pu Zhao, Beijing (CN); Jingjing Ye, Beijing (CN); Yun Liang, Beijing (CN); Xiuhua Hou, Beijing (CN); Linlin Gao, Beijing (CA); Lingxu Liu, Beijing (CN); Benzhong Chai, Beijing (CN)

Correspondence Address: PENNIE AND EDMONDS, 1155 AVENUE OF THE AMERICAS, NEW YORK, NY, 100362711

(21) Appl. No.: 10/125,327

(22) Filed: Apr. 18, 2002

(30) Foreign Application Priority Data
Apr. 18, 2001 (CN) 01110733.2

(51) Int. Cl. C02F 3/00

(52) U.S. Cl. 210/616

(57) ABSTRACT

The present invention relates to a process for biochemical treatment of waste water. The process uses a nano material such as carbon black to induce micro to degrade organic pollutants in the waste water which are generally unable or hard to be degraded and thereby greatly enhance the effect of biological cleaning of waste water. The effect is more prominent for the waste water that is hard to treat by the conventional biochemical treatment, high concentration waste water, and highly poisonous waste water. The process of the present invention is widely usable in the aerobic, oxygen-facultative or anaerobic biochemical treatment systems.

The present invention relates to a process for treating waste water or polluted water, especially an activated sludge process for biochemical treatment of waste water.

In the biochemical treatment of waste water by the activated sludge process, addition into the treating device of an adsorbent such as powder or particle activated carbon, bleaching clay, pulverized coal ash, etc, can improve the settling performance of the sludge floc, enhance the ability of the system to resist the impact load, and increase the capacity of the system. Such a process has been disclosed in related patents such as U.S. Pat. No. 3,904,518, CN 1092386, CN 1016462, etc. U.S. Pat. No. 3,904,518 discloses a process using a mixture of bacteria (activated sludge) and powder activated carbon in the waste water treating zone, which process is referred to as PACT (Powder Activated Carbon Treatment) treatment system. In this process, the powder activated carbon is continuously or intermittently added into an aeration basin in a certain ratio, wherein adsorption and biodegradation proceed simultaneously to attain a better effect. This process may operate in either a continuous mode, or an batch mode. The aeration tank is followed by a clarifier, wherein the activated sludge and powder activated carbon are settled and then returned to the aeration basin. Using this process, although the activated carbon can adsorb the pollutants in the waste water, increase their residence time in the aeration basin, shorten the special distance between the pollutant and microbe, and facilitate the biodegradation reaction, the shortcomings of the process are: 1. since many micropores on the surface of the activated carbon are not large enough to let the microbe bacteria or enzyme molecules in, the organic compounds adsorbed in these pores can not combine with enzyme molecules, resulting in incompletion of the biodegradation reaction due to the steric hindered effect; 2. the refractory compounds in waste water can not be really removed by degradation but can merely be adsorbed, and these organic compounds accumulate in the pores of the activated carbon, occupy more and more adsorptive surface of the activated carbon, and finally result in the loss of the adsorption ability of the activated carbon. Since the content of the activated carbon in the aeration basin generally accounts for 60-85% of the total suspended substances and the fresh activated sludge continuously increases, the activated carbon must be added into the aeration basin in a continuous or intermittent mode during the treatment of the waste water. Generally speaking, 2.5-6,7 kg powder activated carbon should be added for each additional 1 kg microbes or so. Since the adding amount of activated carbon is large, the cost of the waste water treatment must greatly increases. Even if the activated carbon is regenerated, the cost of the waste water treatment will still greatly increase due to the complexity of the regeneration process. Based on the aforesaid various reasons, the processes for biochemical treatment of waste water using the adsorbents in prior art have a great limitation in application and spread.

The present invention is to provide a process for biochemical treatment of waste water with high efficiency using nano materials instead of the process for biochemical treatment of waste water using adsorbents in the prior art so that the above shortcomings of the prior art can be overcome. Due to the unique characters in structure and physical properties and special induction for the microbe of the biochemical treatment of waste water, the present process has effectively overcome the problem of the accumulation of organic compounds in the pores of the absorbent and greatly enhance the biochemical degradation rate of the organic compounds that are hard to be biochemically degraded, therefore it can be effectively used in the biochemical treatment of various waste waters that are hard to degrade.

The process for biochemical treatment of waste water using nano materials is an pioneer invention of the present application. Said nano materials in the present invention are selected from one or more of the group consisting of titania, silicon-based oxide, ferric oxide, zinc oxide, metal iron powder, and carbon black. The process of the present invention for biochemical treatment of waste water using nano materials is based on the following principle and inference.

As mentioned previously, in the activated sludge process for biochemical treatment of waste water, addition into the treating device of an adsorbent such as powder or particle activated carbon, bleaching clay, pulverized coal ash, etc, can improve the settling performance of the sludge floc, enhance the ability of the system to resist the impact load, and increase the capacity of the system. The powder activated carbon is produced by carbonization of carbon-containing materials such as wood, nutshell, coal, etc, and the product is a particle forming by aggregation of thousands of carbon atoms and having a porous structure. In the present invention, nano materials are added into the device for biochemical treatment of waste water to improve the performance of the microbe and decompose and remove the substances in waste water which are hard to biodegrade. Said nano materials are selected from one or more of the croup consisting of titania, silicon-based oxide, ferric oxide, zinc oxide, metal iron powder, and carbon black. Carbon black is preferable. As an example, carbon black is a purely black powder, which consists of element carbon as a major component and small amounts of hydrogen, oxygen, sulfur, ash, tar, and water, The major process for manufacturing carbon black is to crack natural gas, coal gas, or raw oil in a seated furnace, and the resultant product is a very tiny powder particle consisting of several to tens of carbon atoms. The essential differences between powder activated carbon and carbon black are: (1) the particle diameter of powder activated carbon is larger, generally being 0.12-2.75 mm, while that of carbon black is very small, being 9-90 nm, mostly 20-40 nm, therefore carbon black is a nano material, the particle diameter of powder activated carbon is 10000 times of that of carbon black. (2) the micropores in the powder activated carbon have a very large inner surface area, providing the powder activated carbon with a very strong adsorptive capacity, while the particle diameter of carbon black is too small to form a micropore structure, and the adsorptive capacity of carbon black is below 1% of that of powder activated carbon.

The acting modes of the powder activated carbon and carbon black on the biochemical treatment of waste water are completely different due to their great difference in particle diameter and structure.

Powder activated carbon adsorbs large amounts of bacteria and organic compounds in waste water onto its surface by its adsorptive force. The diameters of the micropores on the surface of activated carbon are mostly smaller than 4 nm, and those of bacteria are generally larger than 1000 nm with a small number being 500 nm, therefore microbes can not enter into the micropores and only the microbe-secreted exoenzyme (≦1 nm) having smaller molecular weights or special shapes can degrade the organic compounds adsorbed in the micropores. This causes the incompletion of the biodegradation reaction. In addition, activated carbon can not change the biochemical characters of the microbes, therefore the refractory compounds in waste water can not be really removed by degradation but can merely be adsorbed.

When carbon black is added into the device for biochemical treatment of waste water, it can not precipitate due to its extremely small particle diameter. It is adsorbed onto the bacteria after suspending in water for a while, and at the same time, part of the organic compounds in waste water can also be adsorbed onto the surface of carbon black. The surface of a single bacterium in waste water can adsorb many carbon black particles. Due to the unique property of the nano material, part of carbon black can enter into the inner of the zooglea, thus the combination of carbon black with the microbe bacterium affects and changes the genetic character of the bacteria, mutagenizing or inducing enzyme systems which effectively decompose organic compounds, degrading the organic compounds which can not be degraded originally, and enabling waste water to be deeply purified. On the other hand, since the surface of carbon black has basically no micropore structure, the degradation of the organic compounds adsorbed on carbon black are not affected by the steric hindered effect, enabling the biodegradation of the organic compounds on the surface of carbon black to proceed rather completely, allowing the organic compounds in waste water, especially in high concentration and hard-degraded waste water to be removed by biodegradation under the synergetic action of carbon black and bacteria, and enhancing the effect of the biochemical treatment of waste water. These contents will be further illustrated in the following description and examples.

The process of the present invention for biochemical treatment of waste water using nano materials is realized in the following way.

The present invention is to provide a process for biochemical treatment of waste water, characterized in that a nano material is added into the biochemical treatment system and said nano materials comprise one or more of the group consisting of titania, silicon-based oxide, ferric oxide, zinc oxide, metal iron powder and carbon black. Said process for biochemical treatment of waste water includes the aerobic biochemical treatment system, oxygen-facultative biochemical treatment system, or anaerobic biochemical treatment system. Said biochemical treatment includes the continuous or batch biochemical treatment flow. The mode of adding the nano material includes a continuous or an intermittent one. The form of the added nano material includes wet slurry of the nano material or a dry powder of the nano material.

Carbon black is preferable in said nano materials, its particle diameter ranges from 9 to 90 nm.

The process of the present invention can be operated either continuously or intermittently. Both of the operation modes are equally effective and the selection depends on various factors such as the amount and the pollution extent of waste water to be treated, the request for the attained quality standard, operating cost, investment on the device, available fund, site space, etc.

Carbon black can be added into the biochemical device in any suitable mode, e.g. continuously or intermittently added as an aqueous slurry liquid through a pipe or directly added as a solid. The amount of added carbon black varies mainly according to the property of waste water and the requirement for the extent of the treatment of waste water, being 5-50% of the weight of the activated sludge, preferably 10-15%.

Along with the formation of fresh activated sludge, intermittent supplement of carbon black is needed, and the cycle for supplementing carbon black is 1-100 days, preferably 15-60 days, i.e. carbon black may be supplemented every 1-100 days. preferably every 15-60 days.

The activated organism in the biochemical treatment device can be either a suspension, or a biofilm fixed by a support.

Before entering into the biochemical treatment device, the suspended particles should be first removed from waste water and the pH of waste water should be regulated to 3-12, preferably 6-9. The water temperature is 10-45° C., preferably 25-35° C.

The aforesaid process for biochemical treatment of waste water includes the biochemical treatment flow of the aerobic suspended activated sludge process or the biochemical treatment flow of the biofilm process.

The conditions in the aforesaid biochemical treatment flow of the aerobic suspended activated sludge process or the biochemical treatment flow of the biofilm process can be controlled as follows:

concentration of CODcr in the inlet water; 200-5000 mg/L; (CODcr denotes the chemical oxygen demand)

BOD₅/CODcr of inlet water: 0.01-0.25; (BOD₅ denotes the biochemical oxygen demand in 5 days)

pH of the inlet water: 3-12, preferably 6-9;

temperature of water: 10-45° C., preferably 25-35° C., residence time 2-72 h.

The technical solution and effect of the present invention will be further described bellow in combination with the examples. The protection scope of the present invention conforms to the claims, and is not limited by the following examples. The trademark of the carbon black used in the following examples is N339 and the particle diameter ranges from 26 to 30 nm.

### EXAMPLE 1

The organic synthesis waste water (nitrilon waste water) from some petrochemical plant contained large amounts of oligomers unable to biodegrade, poisonous nitrites (cyanides), and thiocyanides: the concentration of CODcr being 1159 mg/L, that of BOD₅ 174 mg/L, BOD₅/CODcr=0.15. The oligomers are unable to be removed by using the conventional methods of filteration, chamical flocculation and bio-degration. One of the character of polyacrylonitrile is that its molecule contains oganic nitrogen, which is converted into inoganic nitrogen through bio-degration. So, the degrated effect of the oligoomers in the experiments can be evaluated by the amount of NH₄—N generated from the degration of organic nitrogen in the polyacrylonitrile molecule. The pH of the waste water was regulated to about 7.0, and the waste water was introduced into a biofilm reactor filled with a fibrous fixed support. The residence time was 16 h and the temperature of the water was 35° C. The total amount of the solid (carbon black and activated organism) in the biochemical device was about 10 g/L. For comparison, 3 sets of membrane bioreactor units with the same scale were set up: a. conventional aerobic biomembrane process; b. process by adding powder activated carbon; c. process by adding carbon black. The comparison of the waste water treating effect is shown in Table 1 after attaining to steady run.

TABLE 1

| | | Powder activated | |
|---|---|---|---|
| Additive | None | carbon | Carbon black |
| Amount (mg/L) | 0 | 1000 | 300 |
| Time interval (d) | / | 3 | 50 |
| NH₃-N of outlet water (mg/L) | 43 | 101 | 131 |
| Growth rate of NH₃-N (%) | 26.5 | 197.1 | 285.3 |
| CODcr of outlet water (mg/L) | 354 | 199 | 52 |
| Removal rate of CODcr (%) | 69.5 | 82.8 | 95.5 |
| Cost of treatment (Yuan/t) | 1.5 | 2.0 | 1.65 |

### EXAMPLE 2

The same waste water same aerobic biofilm reactor, and same operation conditions as in Example 1 were used, A certain amount of carbon black was added e very day, but the amount was different. The treating effect of the outlet water after the steady state is established is shown in Table 2.

TABLE 2

| Amount (mg/L) | 30 | 100 | 500 | 1000 | 1800 |
|---|---|---|---|---|---|
| CODcr of outlet water (mg/L) | 181 | 54 | 46 | 97 | 216 |
| Removal rate of CODcr (%) | 84.4 | 93.7 | 94.6 | 88.7 | 81.4 |

### EXAMPLE 3

A waste water from the production of organophosphorus pesticide contains 411 mg/L of organophosphor, the concentration of CODcr being 1346 mg/L, that of BOD₅ 210 mg/L, BOD₅/CODcr=0.156. The pH of the waste water was regulated to about 7.0, and the waste water was introduced into an aerobic suspension activated sludge bioreactor. The residence time was 24 h. The total amount of the solid (carbon black and activated organism) in the biochemical treatment device was about 15 g/L. For comparison, 3 sets of biofilm reactor units with the same scale were set up: a. conventional aerobic activated sludge process; b. process by adding powder activated carbon; c. process by adding carbon black. The comparison of the waste water treating effect after the steady state was established is shown in Table 3.

TABLE 3

| | | Powder activated | |
|---|---|---|---|
| Additive | None | carbon | Carbon black |
| Mode of addition | / | Once a day | Once a day |
| Amount (mg/L) | 0 | 1000 | 200 |
| CODcr of outlet water (mg/L) | 480 | 188.4 | 121 |
| Removal rate of CODcr (%) | 67 | 86 | 91 |
| Cost of treatment (Yuan/t) | 1.2 | 1.7 | 1.3 |

### EXAPMLE 4

Polluted water of some city was used for experiment. Two sets of biofilm reactor units were set up to compare the aerobic activated sludge process of adding carbon black and the conventional aerobic activated sludge process. The water temperature was 20° C. and the residence time was 8 h. The amount of activated sludge in the biochemical treatment device was about 4 g/L and the amount of carbon black was 0.4 g/L. The comparison of the waste water treating effect after the steady state was established is shown in Table 4.

| | | | | Aerobic activated sludge | |
|---|---|---|---|---|---|
| | Quality | Conventional aerobic | | process by adding carbon black | |
| | of | activated sludge process | | Concentration | |
| | inlet | Concentration of | Removal | of the outlet | Removal rate |
| | water | outlet water | rate (%) | water | (%) |
| PH | 6.5 | 6.9 | | 6.7 | |
| CODcr | 401 | 80.9 | 79.8 | 38.0 | 90.5 |
| (mg/L) | | | | | |
| BOD₅ | 110 | 22.3 | 79.7 | 7.4 | 93.3 |
| (mg/L) | | | | | |
| SS (mg/L) | 437 | 57.1 | 86.9 | 20.9 | 95.2 |

In summary, the present invention has the following prominent effects:

1. The present invention uses a nano material to induce the micro to degrade organic pollutants in the waste water which are unable or hard to be degraded, and makes use of the character that it not only can adsorb the organic compounds in waste water, but itself also can adhere to the microbe to enhance the efficiency of the biological purification of waste water. Under the synergetic action of the nano material and microbe bacteria, the effect of the biochemical treatment of waste water is markedly improved, and the removal rate of CODcr in waste water greatly rises. Especially for the waste water which is hard to treat by conventional processes, high concentration and highly poisonous waste water, the prominent effect is unexpected. For example, good removing effect has been obtained for the oligomers in nitrilon waste water which are hard to be degrated.

2. The process of the present invention can shorten the time of adaptation and culture of the dominant and effective strain, and produce specific biological strains by mutagenizing or inducting. This is a significant improvement of the traditional biotreatment technique of waste water,

3. The usage cycle of carbon black in the present invention is much longer than that of powder activated carbon, while the amount is much smaller than that of powder activated carbon, generally being ⅕-⅓ of the powder activated carbon. Since the price of carbon black is basically the same as that of powder activated carbon, the treatment cost of the present process is much lower than that of the process using powder activated carbon. Also because the production scale of carbon black is large and the output is high, the present process is readily to widely apply.

4. The amount of the discharged residual sludge is ¼-1/10 of that of the powder activated carbon process, therefore the cost for treating the residual sludge is greatly reduced.

As can be seen from the above discussion that the process for biochemical treatment of waste water initiated by the present inventor using nano materials is widely usable in the aerobic, oxygen-facultative, or anaerobic biochemical treatment system. The effect of the present process is especially prominent for the waste water which is hard to treat by the conventional biochemical treatment process, and high concentration and highly poisonous waste water. The present process has opened a brand-new path for the field of biochemical treatment of waste water.

1. A process for biochemical treatment of waste water, characterized in that nano materials are added into the biochemical treatment system, and said nano materials comprise one or more of the group consisting of titania, silicon-based oxide, ferric oxide, zinc oxide, metal iron powder and carbon black.

2. The process for biochemical treatment of waste water according to claim 1, characterized in that said biochemical treatment of waste water including the aerobic biochemical treatment system, oxygen-facultative biochemical treatment system, or anaerobic biochemical treatment system, and said biochemical treatment including the continuous or intermittent biochemical treatment flow.

3. The process for biochemical treatment of waste water according to claim 1 or 2, characterized in that the mode for adding the nano materials includes a continuous or batch one, and the form of added nano materials includes wet slurry of the nano material or a dry powder of the nano material.

4. The process for biochemical treatment of waste water according to claim 1 or 2, characterized in that said nano material is carbon black.

5. The process for biochemical treatment of waste water according to claim 4, characterized in that the diameter of the added carbon black particle ranges from 9 to 90 nm.

6. The process for biochemical treatment of waste water according to claim 4, characterized in that the amount of the added carbon black is 5-50% of the weight of the activated sludge.

7. The process for biochemical treatment of waste water according to claim 6, characterized in that the amount of the added carbon black is 10-15% of the weight of the activated sludge.

8. The process for biochemical treatment of waste water according to claim 4, characterized in that the interval period for adding carbon black is 1-100 days.

9. The process for biochemical treatment of waste water according to claim 2, characterized in that said process for biochemical treatment of waste water includes the biochemical treatment flow of the aerobic suspending activated sludge process or the biochemical treatment flow of the biofilm process.

10. The process for biochemical treatment of waste water according to claim 9, characterized in that the conditions in the biochemical treatment of waste water are controlled to be: concentration of CODcr in the inlet water: 200-5000 mg/L;
BOD₅/CODcr: 0.01-0.25;
pH of the inlet water: 3-12;
water temperature: 19-45° C.;
residence time: 2-72 h.

11. The process for biochemical treatment of waste water according to claim 9, characterized in that the conditions in the biochemical treatment of waste water are controlled to be: concentration of CODcr in the inlet water: 200-1500 mg/L;
BOD₅/CODcr: 0.05-0.25,
pH of the inlet water: 6-9;
water temperature: 25-35°C.
